(19) United States
(12) Patent Application Publication
(10) Pub. No.: US 2026/0211210 A1
(43) Pub. Date: Jul. 23, 2026

(54) OPTICAL MODULE

(71) Applicant: TDK TAIWAN CORP., Taoyuan City (TW)

(72) Inventors: Chao-Chang HU, Taoyuan City (TW); Yi-Ho CHEN, Taoyuan City (TW); Chia-Che WU, Taoyuan City (TW); Ya-Hsiu WU, Taoyuan City (TW); Yi-Fan LEE, Taoyuan City (TW); Jun-Wei XU, Taoyuan City (TW)

(21) Appl. No.: 19/448,530

(22) Filed: Jan. 14, 2026

Related U.S. Application Data
(60) Provisional application No. 63/748,691, filed on Jan. 23, 2025.

(51) Int. Cl. G02B 7/18; G02B 27/64

(52) U.S. Cl. CPC G02B 7/1805; G02B 27/646

(57) ABSTRACT

An optical module is provided. The optical module includes a carrier, a fixed part, a driving assembly, and a circuit assembly. The carrier is configured to connect an optical element. The carrier is movable relative to the fixed part. The driving assembly is configured to drive the carrier relative to the fixed part. The circuit assembly is affixed to the fixed part. The circuit assembly is configured to connect to an external circuit.

### CROSS REFERENCE TO RELATED APPLICATIONS

This application claims the benefit of U.S. provisional application No. 63/748,691, filed Jan. 23, 2025, the entirety of which is incorporated by reference herein.

### TECHNICAL FIELD

The present disclosure relates to an optical module, and, in particular, to an optical module including a carrier, a fixed part, and a circuit assembly.

### BACKGROUND

With the development of technology, many electronic devices (such as notebook computers, smartphones, and digital cameras) nowadays are equipped with image-capturing and video-recording functions. In addition to developing convenient and lightweight designs as the use of these electronic devices becomes increasingly widespread, it is also necessary to develop more stable and improved optical quality in order to provide users with more options.

The above-mentioned electronic devices having image-capturing and video-recording functions typically include one or more lenses to achieve focusing, zooming, and optical image stabilization (OIS). Therefore, an optical module usually includes multiple driving assemblies for driving optical elements to move. However, in conventional designs, at least one of the driving assemblies is often disposed along the direction in which light enters and/or exits the optical module, resulting in an excessively large distance between the overall center of mass and the center of rotation (e.g., the pivot point), thereby causing issues with tilting or deflection. In view of this, how to precisely adjust the position of the optical elements and avoid tilting or deflection has become an important issue.

In addition, higher requirements have been proposed for the spatial utilization efficiency and structural strength of internal components. A coil, as an important part of a driving or sensing element, often needs to be mounted on a base or a fixed structure and connected to an external circuit through lead wires. However, in existing related technologies, coil installation and lead-wire routing are generally more complicated; during manufacturing, multiple processing steps are often required for positioning, wire arrangement, and fixation, which increases the number of manufacturing stations and thus affects production efficiency and yield.

In traditional designs, coil lead wires may be routed out from different directions, which not only increases the module size but also raises process variation and assembly difficulty. If the coil and lead wires are not properly protected, issues such as coil detachment, wire breakage, or electrical abnormalities may easily occur, further affecting product reliability and lifespan. Therefore, how to simplify the procedures for coil installation and lead-wire routing while enhancing the structural strength and protective capability of the overall assembly has become an important issue urgently needing to be addressed in the relevant technical field.

### BRIEF SUMMARY

The terms “embodiment” and similar expressions (e.g., implementation, arrangement, feature, example, and option) are intended to broadly refer to all subject matter of the present invention and the following claims. Statements containing these terms are to be understood as not limiting the subject matter described herein nor limiting the meaning or scope of the following claims. The embodiments encompassed by the present invention are defined by the claims, not by the summary. This summary provides a high-level overview of various features of the invention and introduces certain concepts that are described in greater detail in the following embodiment sections. This description of the invention is not intended to identify key or essential features of the claimed subject matter, nor is it intended to be used independently to determine the scope of the claimed subject matter. The subject matter should be understood with reference to the appropriate portions of the full specification of the invention, any or all accompanying drawings, and each of the claims.

According to certain aspects of the present disclosure, an optical module is provided, comprising a carrier, a fixed part, a driving assembly, and a circuit assembly. The carrier is configured to connect to an optical element. The carrier is movable relative to the fixed part. The driving assembly is configured to drive the carrier to move relative to the fixed part. The circuit assembly is affixed to the fixed part. The circuit assembly is configured to connect to an external circuit.

According to certain aspects of the present disclosure, the circuit assembly includes a first circuit portion and a substrate. The first circuit portion has a plate-like structure and a first connecting portion. The substrate is made of a plastic or resin material, and the first connecting portion is connected to the substrate.

The foregoing summary is not intended to present every embodiment or every feature of the present disclosure. Instead, the above summary merely provides examples of some of the novel features and characteristics described herein. When taken together with the drawings and the appended claims, the following detailed description of representative embodiments and modes for carrying out the invention will make the above-mentioned features and advantages, as well as other features and advantages of the present disclosure, apparent. In view of the drawings provided below for the detailed description of various embodiments, additional features of the present disclosure will be apparent to those of ordinary skill in the art.

### BRIEF DESCRIPTION OF THE DRAWINGS

The present disclosure can be more fully understood by reading the subsequent detailed description and examples with references made to the accompanying drawings. These drawings illustrate only exemplary embodiments and thus should not be regarded as limiting the various embodiments or the scope of the claims.

FIG. 1 is a perspective view of an optical module and an optical element, according to certain aspects of the present disclosure.

FIG. 2 is an exploded view of the optical module and the optical element, according to certain aspects of the present disclosure.

FIG. 3A is a front perspective view of a carrier of the optical module, according to certain aspects of the present disclosure.

FIG. 3B is a rear perspective view of the carrier, according to certain aspects of the present disclosure.

FIG. 4 is a perspective view of a fixed part of the optical module, according to certain aspects of the present disclosure.

FIG. 5A is a perspective view of a circuit assembly of the optical module, according to certain aspects of the present disclosure.

FIG. 5B is a front view of the circuit assembly, according to certain aspects of the present disclosure.

FIG. 5C is a side view of the circuit assembly, according to certain aspects of the present disclosure.

FIG. 6 is a perspective view of the fixed part, the circuit assembly, and a portion of the driving assembly of the optical module, according to certain aspects of the present disclosure, wherein the fixed part is shown in dashed lines for illustrative purposes.

FIG. 7 is a cross-sectional view of the optical module taken along line A-A of FIG. 1, according to certain aspects of the present disclosure.

FIG. 8A is a top view of the optical module, according to certain aspects of the present disclosure, with the housing removed and the fixed part shown in dashed lines for illustrative purposes.

FIG. 8B is a front view of the optical module, according to certain aspects of the present disclosure, with the housing removed for illustrative purposes.

FIG. 9A is a bottom view of a supporting assembly of the optical module, according to certain aspects of the present disclosure.

FIG. 9B is a bottom view of the optical module, according to certain aspects of the present disclosure, with the housing removed and the fixed part shown in dashed lines for illustrative purposes.

FIG. 10 is a perspective view of the optical module, according to certain aspects of the present disclosure, wherein the fixed part and the carrier are shown in dashed lines for illustrative purposes.

FIG. 11 is a cross-sectional view of the optical module taken along line B-B of FIG. 1, according to certain aspects of the present disclosure.

### DETAILED DESCRIPTION

Multiple embodiments are described with reference to the drawings, in which like reference numerals are used throughout to designate similar or equivalent elements. The drawings are not drawn to scale, and are provided merely to illustrate the features and characteristics of the present disclosure. It should be understood that numerous specific details, relationships, and methods are described to provide a thorough understanding. However, one of ordinary skill in the art will readily appreciate that multiple embodiments may be practiced without one or more of the specific details, or using other methods. In some instances, well-known structures or operations are not shown in detail for purposes of illustration. The various embodiments are not limited to the illustrated sequence of actions or events, as some actions may occur in different sequences and/or concurrently with other actions or events. Furthermore, not all illustrated actions or events are required for practicing certain aspects and features of the present disclosure.

For purposes of the present embodiment, unless explicitly stated otherwise, the singular includes the plural and vice versa. The term “including” means “including but not limited to.” In addition, approximate terms such as “about,” “almost,” “substantially,” or “approximately,” and similar expressions may be understood herein to mean, for example, “at,” “near,” “nearly at,” “within 3-5% of,” “within acceptable manufacturing tolerances,” or any logical combination thereof. Additionally, the terms “vertical” or “horizontal” are intended to further include directions within “3-5% of” vertical or horizontal, respectively. Furthermore, directional terms such as “top,” “bottom,” “left,” “right,” “upper,” and “lower” are intended to refer to equivalent directions as depicted in the referenced illustrations; as understood from the context of the referenced object or component, such as its customary orientation; or other similar descriptions.

It will be understood that although the terms “first,” “second,” and the like may be used herein to describe various elements, layers, and/or portions, such elements, layers, and/or portions should not be limited by these terms, which are used merely to distinguish one element, layer, or portion from another. Thus, a first element, layer, and/or portion discussed below may be referred to as a second element, layer, and/or portion without departing from the teachings of certain embodiments of the present disclosure. Additionally, for brevity, the terms “first,” “second,” and the like may be omitted in the specification when distinguishing between different elements. Without departing from the scope defined by the appended claims, the first element and/or second element recited in the claims may be interpreted as any element that fits the description in the specification.

It should be noted that the technical solutions provided by different embodiments below may be interchanged, combined, or used in mixed form to constitute another embodiment, so long as doing so does not depart from the spirit of the present disclosure.

The present disclosure relates to an optical module comprising a carrier, a fixed part, a driving assembly, and a circuit assembly. The optical module is capable of providing multiple types of movement and features a simplified structural configuration and an optimized driving-connection design, thereby improving driving efficiency, structural stability, and circuit integration. This enables more precise or diversified optical control to adjust the imaging performance of the optical module so as to accommodate different photographic requirements.

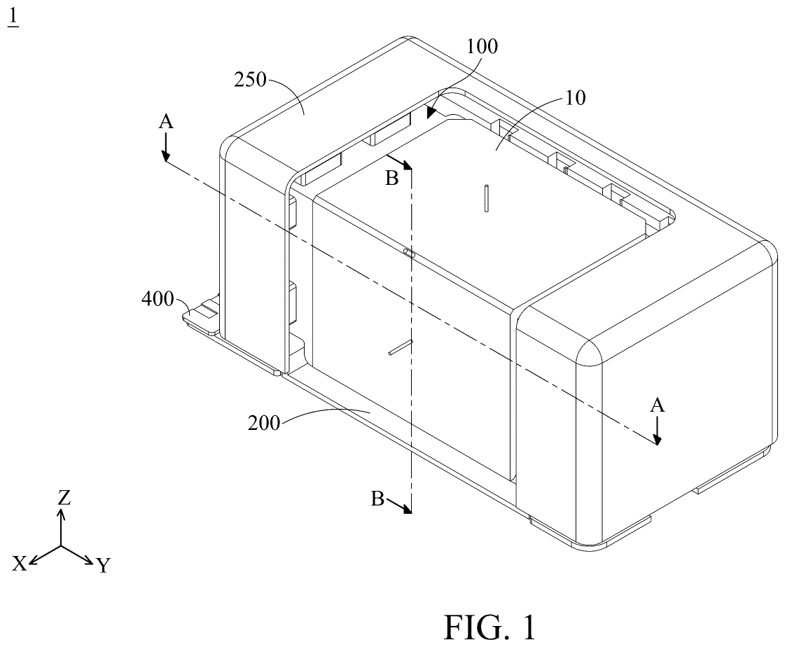

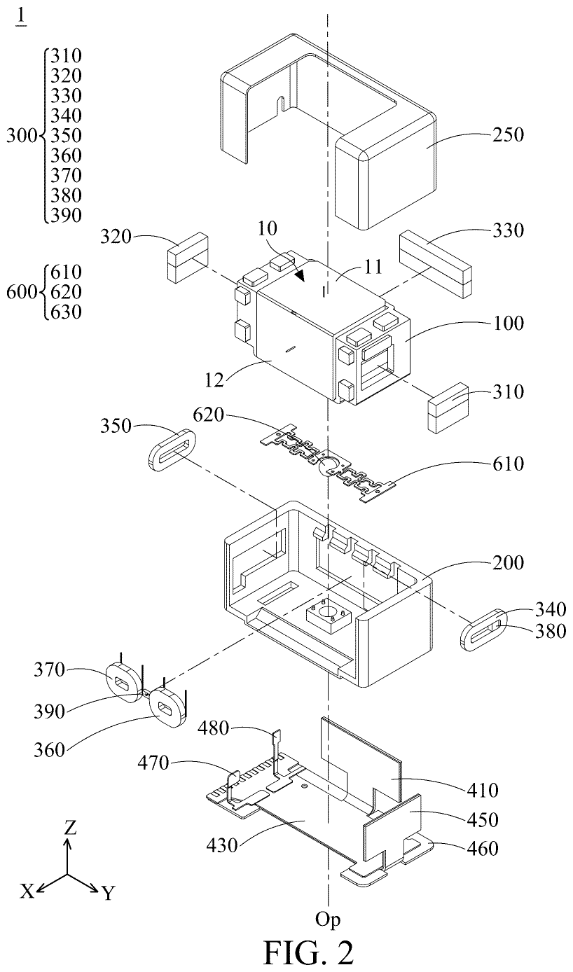

First, reference is made to FIGS. 1 and 2 together. FIG. 1 is a perspective view of an optical module 1 and an optical element 10, according to certain aspects of the present disclosure. FIG. 2 is an exploded view of the optical module 1 and the optical element 10 according to certain aspects of the present disclosure.

The optical module 1 is configured to drive the optical element 10. The optical module 1 includes a carrier 100, a fixed part 200, a housing 250, a driving assembly 300, a circuit assembly 400, a damping assembly, and a supporting assembly 600. The carrier 100 is configured to connect to the optical element 10. The carrier 100 is movable relative to the fixed part 200. The driving assembly 300 is configured to drive the carrier 100 to move relative to the fixed part 200. The circuit assembly 400 is affixed to the fixed part 200. The housing 250 is affixed to the circuit assembly 400 to accommodate all components of the optical module 1. The circuit assembly 400 is configured to connect to an external circuit. The damping assembly is configured to suppress abnormal vibration of the carrier 100. The carrier 100 is movable relative to the fixed part 200 via the supporting assembly 600.

The optical element 10 has a main optical axis Op and the optical element 10 includes an incident surface 11 and an exit surface 12. The optical element 10 is fixedly connected to the carrier 100, such that it moves together with the carrier 100 relative to the fixed part 200 to achieve a desired optical effect. The optical element 10 may be, for example, a prism that functions to change the traveling direction of light.

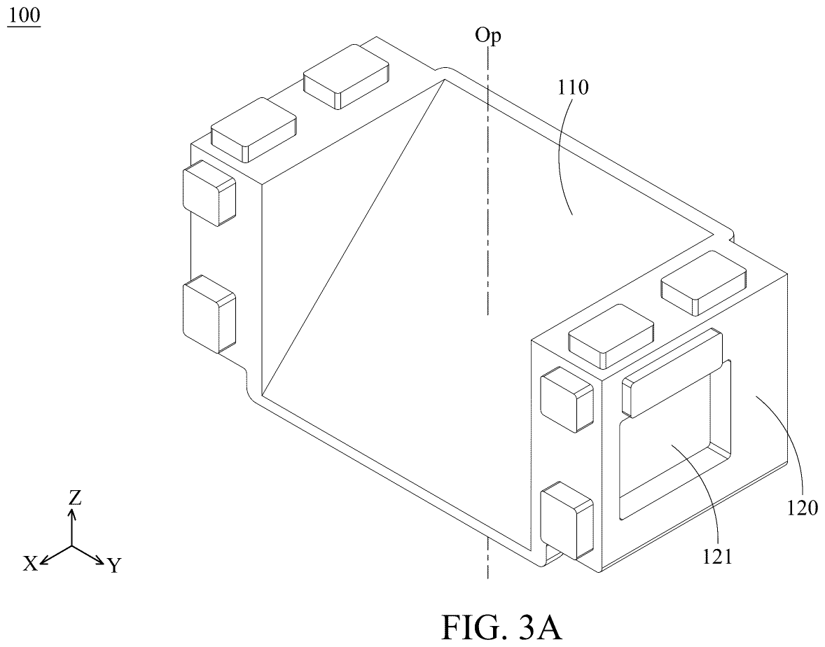

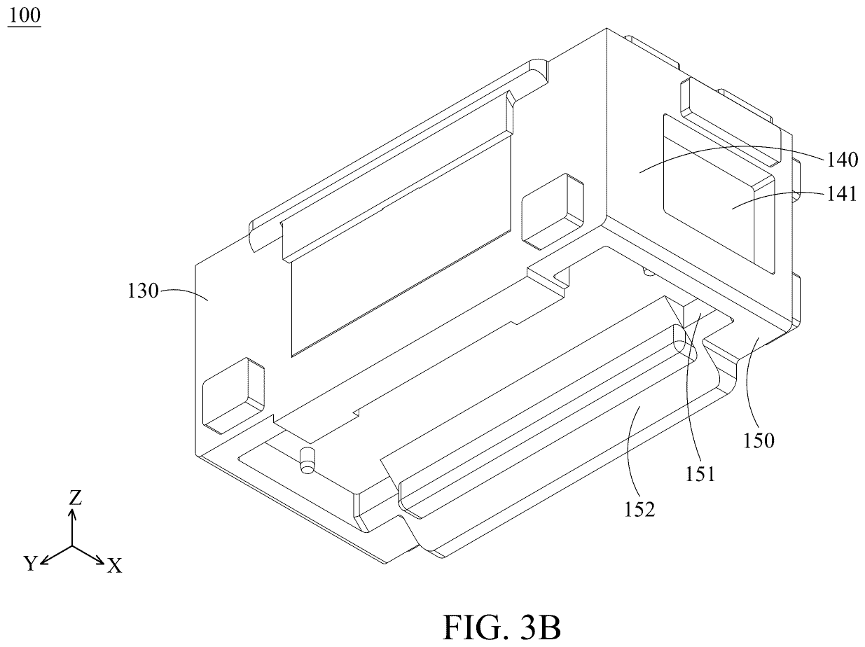

In the embodiment shown in FIG. 2, the incident surface 11 is the surface through which light enters the optical module 1 and is perpendicular to the main optical axis Op. The exit surface 12 is the surface through which light exits the optical module 1 and is perpendicular to the incident surface 11. The reflective surface of the optical element 10 is parallel to an inclined surface 110 of the carrier 100 (see FIG. 3A). By means of the optical characteristics of the optical element 10, the traveling direction of light is changed after reaching the reflective surface, thereby obtaining a desired optical effect. In some embodiments, light may enter the optical module 1 through the incident surface 11 along the main optical axis Op, and then change its traveling direction via the reflective surface (e.g., from the Z direction to the X direction), and then exit the optical module 1 through the exit surface 12.

Next, reference is made to FIGS. 3A and 3B together. FIG. 3A is a front perspective view of the carrier 100 of the optical module 1, according to certain aspects of the present disclosure. FIG. 3B is a rear perspective view of the carrier 100, according to certain aspects of the present disclosure.

The carrier 100 is rotatable relative to the fixed part 200 with the supporting assembly 600 serving as a pivot. The carrier 100 includes an inclined surface 110, side surfaces 120 and 140, a rear side 130, and a bottom surface 150.

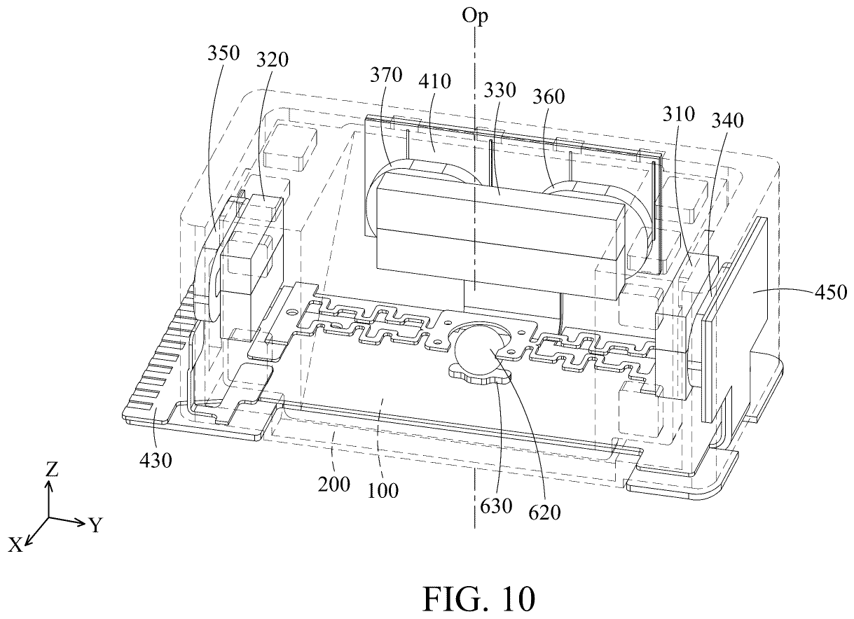

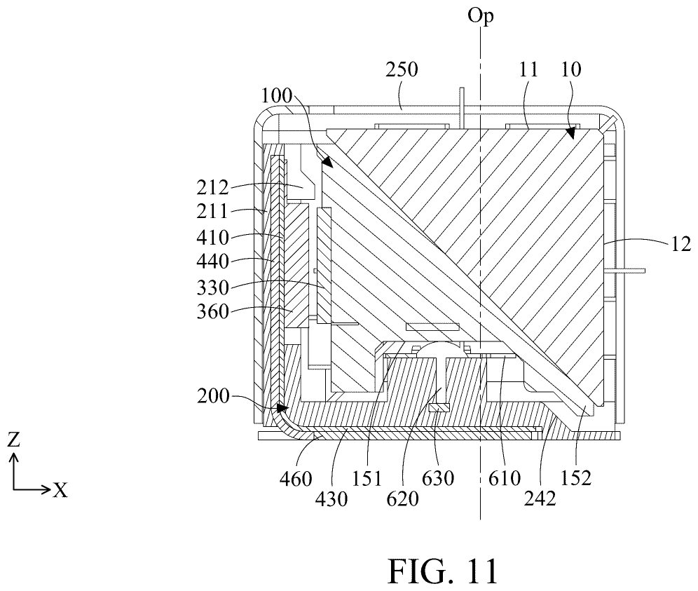

The side surfaces 120 and 140 respectively include recesses 121 and 141 configured to accommodate magnetic elements 310 and 320 of the driving assembly 300 (as described in more detail below). The bottom surface 150 includes a recessed portion 151 and a protruding edge 152. The recessed portion 151 is configured to accommodate the supporting assembly 600 so that the overall center of mass of the carrier 100 is closer to the optical element 10; this configuration is described in detail below with reference to FIGS. 10 and 11. The protruding edge 152 extends along the optical element 10.

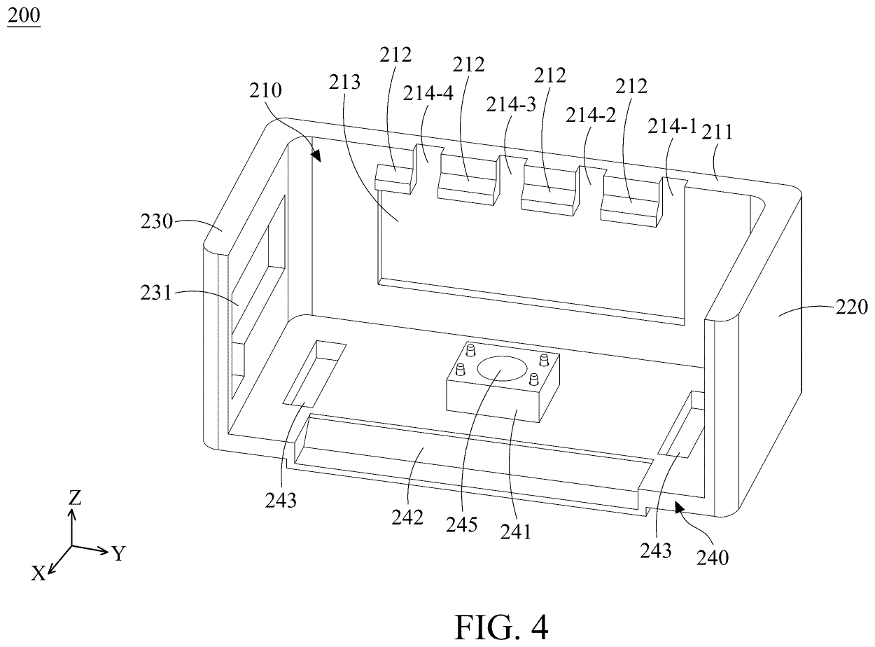

Next, reference is made to FIG. 4. FIG. 4 is a perspective view of the fixed part 200 of the optical module 1, according to certain aspects of the present disclosure.

The fixed part 200 includes a first side 210, a second side 220, a third side 230, and a fourth side 240. The first side 210 includes a supporting portion 211, a plurality of tab portions 212 (only one is labeled in FIG. 4), a groove 213, and a plurality of channels 214-1, 214-2, 214-3, and 214-4. The supporting portion 211 has a plate-like structure. The tab portions 212 are configured to restrict the carrier 100 to move within a limited range. For example, the tab portions 212 may prevent the carrier 100 from coming into direct contact with the first side 210 when the carrier 100 moves relative to the fixed part 200 (the movement of the carrier 100 relative to the fixed part 200 is described in detail below with reference to FIGS. 10 and 11).

The groove 213 is configured to accommodate a third coil 360 and a fourth coil 370 of the driving assembly 300. The channels 214-1, 214-2, 214-3, and 214-4 extend from the groove 213 to an edge of the fixed part 200 to form open channels. The extending directions of the channels 214-1, 214-2, 214-3, and 214-4 are parallel to one another. The tab portions 212 are located between the channels 214-1, 214-2, 214-3, and 214-4.

A first coil 340 of the driving assembly 300 and a sensing element 380 are disposed on the second side 220. A first coil hole (not shown) is formed in the second side 220 such that the first coil 340 and the sensing element 380 are disposed in the first coil hole. A potting material may be provided around the first coil 340 and inside the first coil hole to further secure the first coil 340. The potting material may be an insulating adhesive.

The third side 230 is parallel to the second side 220. The third side 230 has a second coil hole 231. A second coil 350 of the driving assembly 300 and a sensing element 390 are disposed in the second coil hole 231 of the third side 230. A potting material may be provided around the second coil 350 and inside the second coil hole 231.

When viewed along a direction that is parallel to the third side 230 and the first side 210 (that is, when viewed from the top to the bottom along the Z direction), the third side 230 covers the second coil 350.

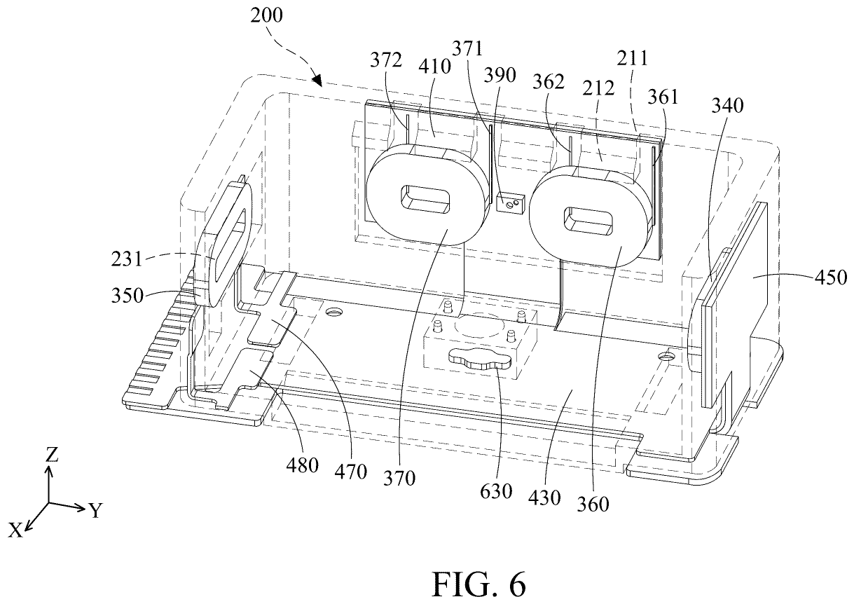

The fourth side 240 includes a boss 241, an recessed corner 242, and through holes 243. The supporting assembly 600 is affixed to the boss 241, and the boss 241 has a recessed hole 245 for accommodating the supporting assembly 600. The recessed corner 242 is adjacent to the protruding edge 152 of the carrier 100. The recessed corner 242 is configured to be recessed on the side facing the protruding edge 152 so as to accommodate the protruding edge 152 and is configured to protrude toward the circuit assembly 400 (see FIG. 6).

In detail, the protruding edge 152 extends in a direction that is parallel to the inclined surface 110 toward the recessed corner 242. The extending direction of the protruding edge 152 is neither parallel nor perpendicular to the incident surface 11 or the exit surface 12, and the shortest distance between the protruding edge 152 and the recessed corner 242 is smaller than the shortest distance between the optical element 10 and the recessed corner 242. Through this structural design, collision and damage between the optical element 10 and the fixed part 200 can be avoided.

Next, reference is made to FIGS. 2 and 6 together. FIG. 6 is a perspective view of the fixed part 200, the circuit assembly 400, and portions of the driving assembly 300, according to certain aspects of the present disclosure, wherein the fixed part 200 is shown in dashed lines for illustrative purposes.

The driving assembly 300 includes a first magnetic element 310, a second magnetic element 320, a third magnetic element 330, a first coil 340, a second coil 350, a third coil 360, a fourth coil 370, and sensing elements 380 and 390.

The first magnetic element 310, the second magnetic element 320, and the third magnetic element 330 are disposed on the carrier 100. The first magnetic element 310 is disposed in the recess 121 of the side surface 120, the second magnetic element 320 is disposed in the recess 141 of the side surface 140, and the third magnetic element 330 is disposed on the rear side 130.

The first coil 340, the second coil 350, the third coil 360, the fourth coil 370, and the sensing elements 380 and 390 are disposed on the fixed part 200. The first coil 340 and the sensing element 380 are disposed in a first coil hole (not shown) of the second side 220. The second coil 350 is disposed in the second coil hole 231 of the third side 230. The third coil 360, the fourth coil 370, and the sensing element 390 are disposed in the groove 213 of the first side 210. Lead wires 361, 362, 371, and 372 (see FIG. 6) of the third coil 360 and the fourth coil 370 are disposed in the channels 214-1, 214-2, 214-3, and 214-4. The first coil 340, the second coil 350, the third coil 360, and the fourth coil 370 are flexible printed circuit (FPC) coils.

The first coil 340 and the first magnetic element 310 form a corresponding driving pair and jointly drive the carrier 100 to move in one direction. Through the electromagnetic driving force generated between the first coil 340 and the first magnetic element 310, the carrier 100 is driven to perform a first movement relative to the fixed part 200. The first movement of the carrier 100 is a rotational movement having a rotation axis parallel to the Z-axis direction. The sensing element 380 is located within the first coil 340 and senses the first magnetic element 310 and the first movement of the carrier 100.

The second magnetic element 320 and the second coil 350 form a corresponding driving pair and jointly drive the carrier 100 to move in one direction. Through the electromagnetic driving force generated between the second coil 350 and the second magnetic element 320, the carrier 100 is driven to perform a second movement relative to the fixed part 200. The second movement of the carrier 100 is a rotational movement having a rotation axis parallel to the Z-axis direction.

The third coil 360, the fourth coil 370, and the third magnetic element 330 form a corresponding driving pair and jointly drive the carrier 100 to move in another direction. Through the electromagnetic driving force generated between the third coil 360, the fourth coil 370, and the third magnetic element 330, the carrier 100 is driven to perform a third movement relative to the fixed part 200. The third movement of the carrier 100 is a rotational movement having a rotation axis parallel to the Y direction. The sensing element 390 is located between the third coil 360 and the fourth coil 370 and senses the third magnetic element 330 and the third movement of the carrier 100.

The direction of the first movement is perpendicular to the direction of the third movement. The direction of the second movement is parallel to the direction of the first movement.

When viewed along a direction that is parallel to the first side 210 (that is, when viewed from the top to the bottom along the Z direction), the first side 210 does not fully cover nor fully enclose the third coil 360 and the fourth coil 370. That is, because the channels 214-1, 214-2, 214-3, and 214-4 are open channels, the first side 210 does not fully cover nor fully enclose the third coil 360 and the fourth coil 370.

Lead wires 361 and 362 of the third coil 360 are parallel to the first side wall 210 and the main optical axis Op. The lead wires 361 and 362 extend from the same side of the third coil 360. For example, in the embodiment shown in FIG. 6, when facing the third coil 360, the two lead wires 361 and 362 extend above the third coil 360 and are respectively electrically connected to the circuit assembly 400 (as described in more detail below).

The lead wires 371 and 372 of the fourth coil 370 are likewise parallel to the first side wall 210 and the main optical axis Op. The lead wires 371 and 372 extend from the same side of the fourth coil 370. When facing the fourth coil 370, the two lead wires 371 and 372 extend above the fourth coil 370 and are respectively electrically connected to the circuit assembly 400 (as described in more detail below).

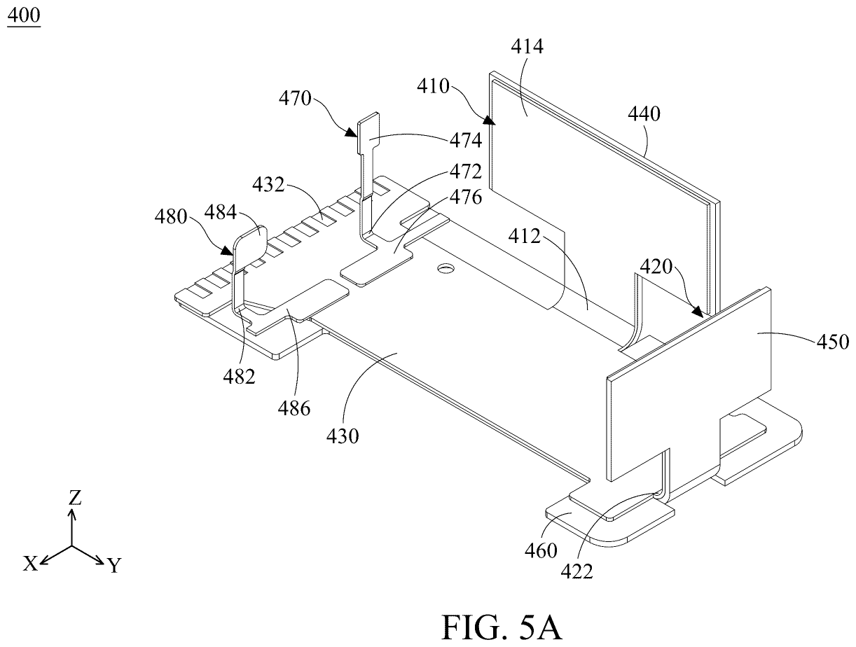

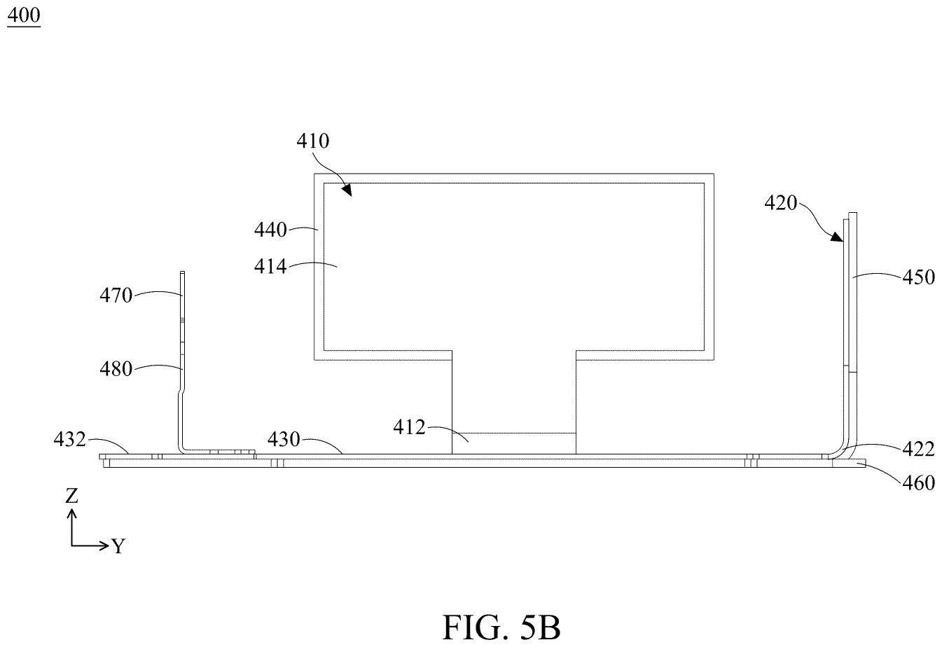

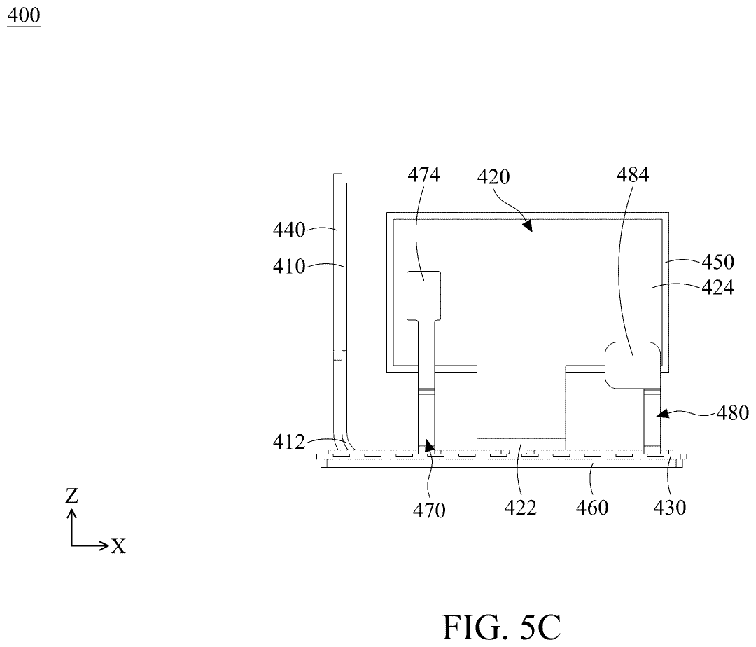

Next, reference is made to FIGS. 5A to 5C together. FIG. 5A is a perspective view of the circuit assembly 400 of the optical module 1, according to certain aspects of the present disclosure. FIG. 5B is a front view of the circuit assembly 400, according to certain aspects of the present disclosure. FIG. 5C is a side view of the circuit assembly 400, according to certain aspects of the present disclosure.

The circuit assembly 400 includes a first circuit portion 410, a second circuit portion 420, a substrate 430, a first reinforcing element 440, a second reinforcing element 450, a third reinforcing element 460, a third circuit portion 470, and a fourth circuit portion 480.

The first circuit portion 410 has a plate-like structure and includes a first connecting portion 412 and a main board 414. The first connecting portion 412 is connected to the substrate 430 and the main board 414. The main board 414 is connected to the third coil 360 and the fourth coil 370.

The second circuit portion 420 has a plate-like structure and includes a second connecting portion 422 and a main board 424 (FIG. 5C). The second connecting portion 422 is connected to the substrate 430 and the main board 424. The main board 424 is connected to the first coil 340.

The first reinforcing element 440 has a plate-like structure and is made of a metal material. The first circuit portion 410 is disposed on the first reinforcing element 440. Because the first reinforcing element 440 is made of a metal material, it reinforces the structure of the first circuit portion 410 and prevents the first circuit portion 410 from being damaged by external impact.

The second circuit portion 420 is disposed on the second reinforcing element 450. The second reinforcing element 450 is made of a metal material. Because the second reinforcing element 450 is made of a metal material, it reinforces the structure of the second circuit portion 420 and prevents the second circuit portion 420 from being damaged by external impact.

When viewed along the direction of the thickness of the first reinforcing element 440, for example, along the direction of FIG. 5B (the X-axis direction), the boundary of the first circuit portion 410 at least partially overlaps the first reinforcing element 440. In other words, the size of the first reinforcing element 440 is greater than or equal to the size of the first circuit portion 410. In the embodiment shown in the drawings, the size of the first reinforcing element 440 is greater than the size of the first circuit portion 410.

Similarly, when viewed along the direction of the thickness of the second reinforcing element 450, for example, along the direction of FIG. 5C (the Y-axis direction), the boundary of the second circuit portion 420 at least partially overlaps the second reinforcing element 450. In other words, the size of the second reinforcing element 450 is greater than or equal to the size of the second circuit portion 420. In the embodiment shown in the drawings, the size of the second reinforcing element 450 is greater than the size of the second circuit portion 420.

The substrate 430 extends parallel to the fourth side 240. The substrate 430 is made of a plastic or resin material and is disposed on the third reinforcing element 460. The substrate 430 is fixedly connected to the third reinforcing element 460. The first reinforcing element 440, the third reinforcing element 460, and the second reinforcing element 450 have an integrally formed structure. The first circuit portion 410, the substrate 430, and the second circuit portion 420 also have an integrally formed structure, and the first circuit portion 410, the substrate 430, and the second circuit portion 420 are electrically connected to one another. The substrate 430 has a connecting portion 432 that extends from the substrate 430 to the outside of the fixed part 200 so as to be connected to an external module, such as a control module.

The third reinforcing element 460 extends parallel to the fourth side 240. The third reinforcing element 460 is disposed between the substrate 430 and the housing 250 and is attached to the fourth side 240, thereby strengthening the structure of the substrate 430 and preventing deformation caused by external forces.

The third reinforcing element 460 and the substrate 430 extend in a plane defined by the Y-axis and the X-axis. The first reinforcing element 440 and the first circuit portion 410 extend from the substrate 430 along the Z-axis in a plane defined by the Z-axis and the Y-axis. The second reinforcing element 450 and the second circuit portion 420 extend from the substrate 430 along the Z-axis in a plane defined by the Z-axis and the X-axis.

Accordingly, the extending direction of the first reinforcing element 440 is not parallel to the extending direction of the third reinforcing element 460. The extending direction of the second reinforcing element 450 is also not parallel to the extending direction of the third reinforcing element 460. The extending direction of the first circuit portion 410 is not parallel to the extending direction of the substrate 430. Furthermore, the extending direction of the second circuit portion 420 is not parallel to the extending direction of the substrate 430.

In other words, the extending directions of the first reinforcing element 440, the third reinforcing element 460, and the second reinforcing element 450 are not parallel to one another. The extending directions of the first circuit portion 410, the substrate 430, and the second circuit portion 420 are also not parallel to one another.

The third circuit portion 470 extends from the substrate 430 in parallel with the second circuit portion 420. The third circuit portion 470 has a plate-like structure and includes a third connecting portion 472, a main board 474, and a bottom portion 476. The third connecting portion 472 connects the bottom portion 476 and the main board 474. The main board 474 is connected to one end of the second coil 350. The bottom portion 476 is fixedly connected to the substrate 430.

The fourth circuit portion 480 extends from the substrate 430 in parallel with the second circuit portion 420. The fourth circuit portion 480 has a plate-like structure and includes a fourth connecting portion 482, a main board 484, and a bottom portion 486. The fourth connecting portion 482 connects the bottom portion 486 and the main board 484. The main board 484 is connected to the other end of the second coil 350. The bottom portion 486 is fixedly connected to the substrate 430.

The edge of the third reinforcing element 460 may be fastened to the housing 250, for example, by welding, so as to form a protective space in which the components of the optical module 1 (the carrier 100, the fixed part 200, the supporting assembly 600, and the driving assembly 300) are accommodated. This effectively prevents interference such as dust from the external environment. The third reinforcing element 460 further reinforces the bottom structure of the optical module 1 and supports its weight, thereby preventing deformation caused by external forces.

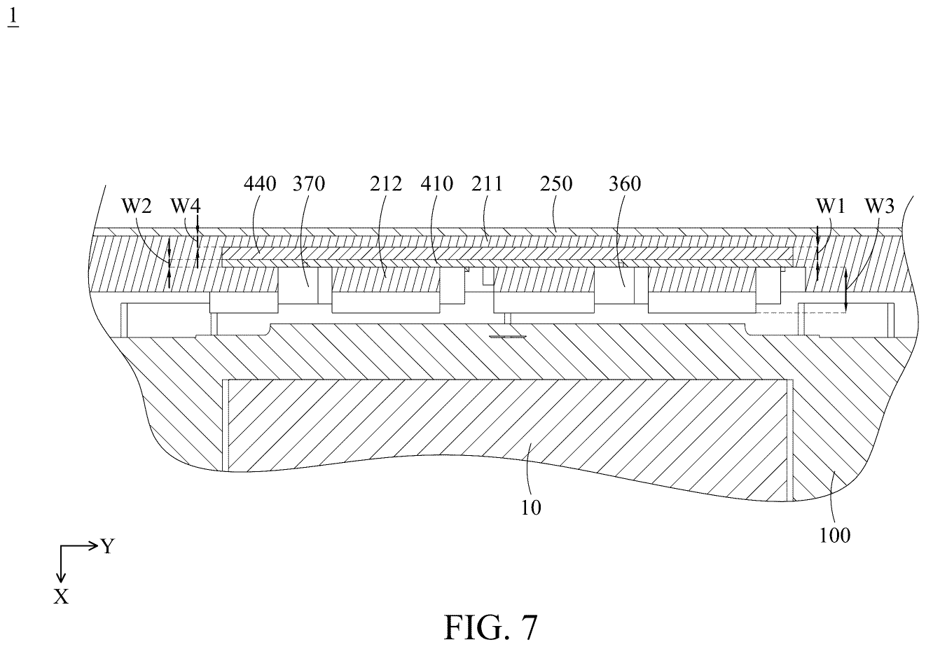

Next, reference is made to FIGS. 6 and 7 together. FIG. 6 is a perspective view of the fixed part 200, the circuit assembly 400, and a portion of the driving assembly 300 of the optical module 1, according to certain aspects of the present disclosure, wherein the fixed part 200 is shown in dashed lines for illustrative purposes. FIG. 6 shows in greater detail the connection between the fixed part 200, the circuit assembly 400, and the driving assembly 300. FIG. 7 is a cross-sectional view of the optical module 1 taken along line A-A of FIG. 1, according to certain aspects of the present disclosure.

The first coil 340, the sensing element 380, the second coil 350, the third coil 360, the fourth coil 370, and the sensing element 390 of the driving assembly 300 are affixed to the circuit assembly 400 and electrically connected to the circuit assembly 400 so as to be connected to an external circuit, thereby achieving control and driving functionality. The fixed part 200 is formed on the circuit assembly 400, further providing protection and enhancing the structural strength.

The first coil 340 and the sensing element 380 of the driving assembly 300 are affixed to the second circuit portion 420 and electrically connected to the second circuit portion 420. One end (e.g., input end) of the second coil 350 is affixed to the third circuit portion 470 and is electrically connected to the third circuit portion 470, while the other end (e.g., output end) is affixed to the fourth circuit portion 480, and is electrically connected to the fourth circuit portion 480.

The third coil 360, the fourth coil 370, and the sensing element 390 are affixed to the first circuit portion 410. The lead wire 361 of the third coil 360 extends into the channel 214-1, the lead wire 362 of the third coil 360 extends into the channel 214-2, the lead wire 371 of the fourth coil 370 extends into the channel 214-3, and the lead wire 372 of the fourth coil 370 extends into the channel 214-4. The lead wires 361, 362, 371, and 372 extending into the channels 214-1, 214-2, 214-3, and 214-4 are electrically connected to the first circuit portion 410.

The main board 414 of the first circuit portion 410 is located within the first side 210. That is, at least a portion of the main board 414 of the first circuit portion 410 is positioned between the supporting portion 211 and the tab portions 212.

The main board 424 of the second circuit portion 420 is located within the second side 220. The main board 474 of the third circuit portion 470 and the main board 484 of the fourth circuit portion 480 are located within the third side 230. The substrate 430 is partially located within the fourth side 240.

In the present embodiment, the first circuit portion 410 and the second circuit portion 420 are connected to the first coil 340, the third coil 360, and the fourth coil 370 by a configuration in which the coils are attached to the extending main boards. If only metallic conductors were used for such connections, the spatial utilization efficiency would be too low, and the spacing between metal components would be relatively large, resulting in crowding within the inner space of the fixed part 200, increased process complexity, and a higher risk of short circuits due to manufacturing errors. By extending the first reinforcing element 440 to the first circuit portion 410 and extending the second reinforcing element 450 to the second circuit portion 420, the first circuit portion 410 and the second circuit portion 420 can be positioned and supported.

In other words, in this embodiment, the configuration of the circuit assembly 400 and the fixed part 200 optimizes internal routing and impact resistance within the optical module 1.

Next, reference is made to FIG. 7. FIG. 7 illustrates in greater detail the tab portions 212, the supporting portion 211, the first reinforcing element 440, and the first circuit portion 410.

As shown in the drawing, the thickness W1 of the first reinforcing element 440 is greater than the thickness W2 of the first circuit portion 410. The maximum thickness W3 of the tab portions 212 is greater than the maximum thickness W4 of the supporting portion 211. The maximum thickness W4 of the supporting portion 211 is greater than the maximum thickness W2 of the first circuit portion 410. The maximum thickness W4 of the supporting portion 211 is smaller than the maximum thickness W1 of the first reinforcing element 440.

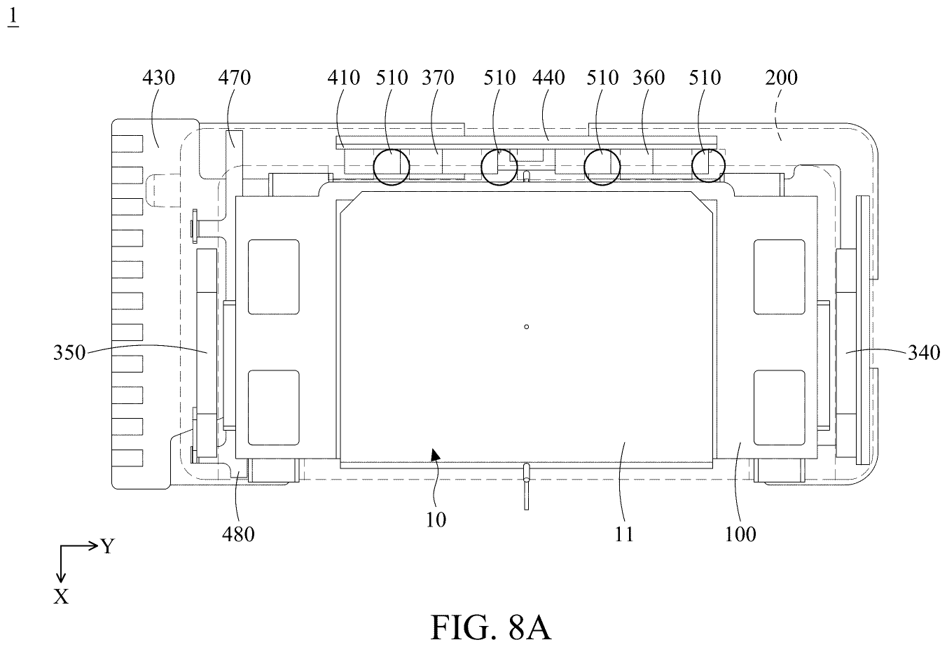

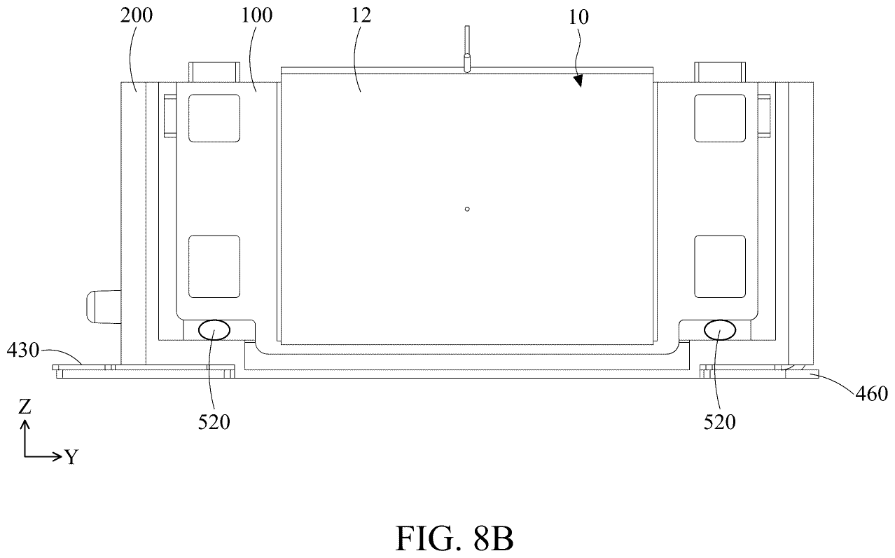

Next, reference is made to FIGS. 8A and 8B together. FIG. 8A is a top view of the optical module 1 according to certain aspects of the present disclosure, wherein the housing 250 is removed for illustrative purposes and the fixed part 200 is shown in dashed lines. FIG. 8B is a front view of the optical module 1 according to certain aspects of the present disclosure, wherein the housing 250 is removed for illustrative purposes.

The damping assembly may be, for example, a gel or similar material, and is movably connected between the fixed part 200 and the carrier 100 to suppress abnormal vibrations of the carrier 100. The damping assembly includes a plurality of first damping elements 510 and a plurality of second damping elements 520. The first damping elements 510 are in direct contact with the first circuit portion 410. The first damping elements 510 are located in the channels 214-1, 214-2, 214-3, and 214-4. The first circuit portion 410 and the carrier 100 are movably connected by the first damping elements 510.

The second damping elements 520 are in direct contact with the fixed part 200. The fourth side 240 and the carrier 100 are movably connected by the second damping elements 520.

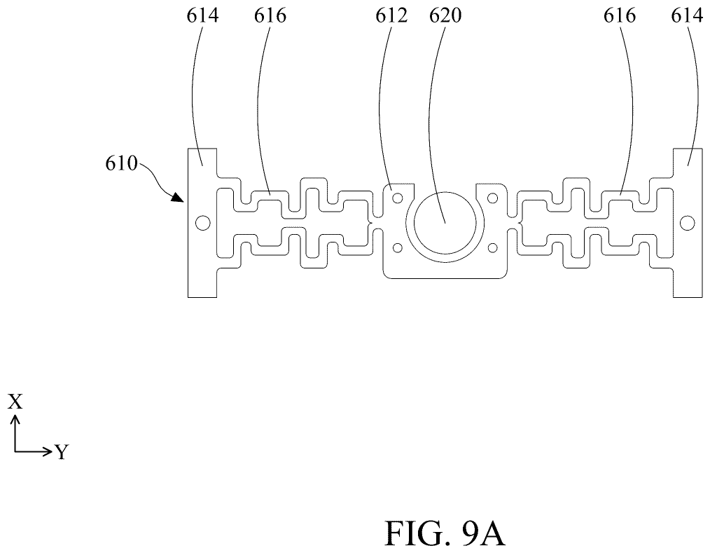

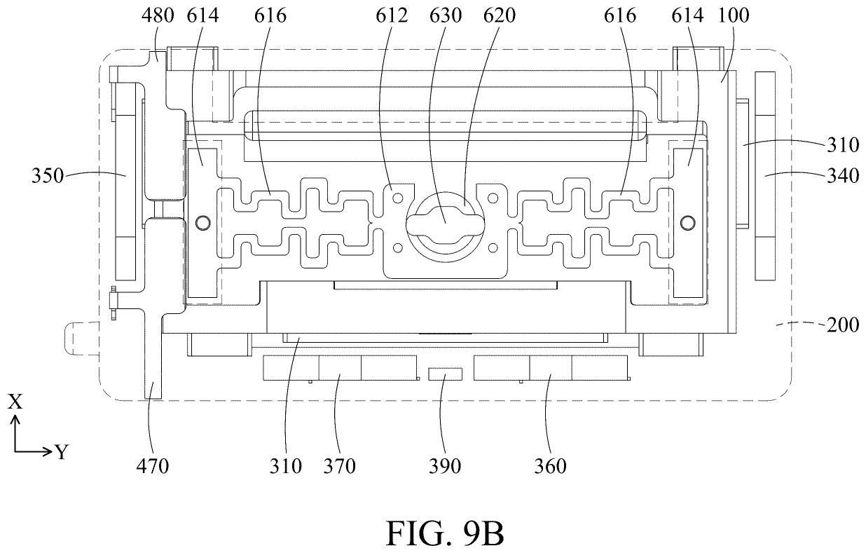

Next, reference is made to FIGS. 9A and 9B together. FIG. 9A is a bottom view of the supporting assembly 600 of the optical module 1, according to certain aspects of the present disclosure. FIG. 9B is a bottom view of the optical module 1, according to certain aspects of the present disclosure, wherein the housing 250 is removed and the fixed part 200 is shown in dashed lines for illustrative purposes.

The supporting assembly 600 includes a supporting element 620, an elastic element 610, and a reinforcing element 630. The supporting element 620 is movable relative to the carrier 100 and the fixed part 200. The driving assembly 300 drives the carrier 100 to perform rotational movement with the supporting element 620 serving as the center of rotation. The supporting element 620 is located between the carrier 100 and the fixed part 200 and provides support when the carrier 100 moves relative to the fixed part 200.

The supporting element 620 may be spherical so as to provide stable support when the carrier 100 moves relative to the fixed part 200 in various directions, and to make such movement smooth and continuous. The supporting element 620 is disposed in the recessed hole 245 of the boss 241, that is, at a position closer to the exit surface 12 of the optical element 10.

The reinforcing element 630 is disposed within the boss 241 of the fixed part 200 (see FIG. 6), the reinforcing element 630 is made of a metal material, and is in direct contact with the supporting element 620. The boss 241 and the reinforcing element 630 together provide supporting force to the supporting element 620, while also positioning the supporting element 620 closer to the center of mass of the carrier 100 along the Z-axis.

The elastic element 610 is disposed between the carrier 100 and the fixed part 200. The recessed portion 151 of the carrier 100 has a stepped structure, and the elastic element 610 is disposed within the recessed portion 151. The recessed portion 151 may be designed into any other structure according to requirements or other manufacturing constraints.

The elastic element 610 connects the fixed part 200 and the carrier 100, and is designed with a shape corresponding to the recessed portion 151 (see FIG. 3). It is disposed parallel to the incident surface 11 of the optical element 10, that is, perpendicular to the exit surface 12. The elastic element 610 may be an elastic member, a spring, a leaf spring, or similar structure, and provides a restoring force when the carrier 100 moves relative to the fixed part 200.

The elastic element 610 includes a first connecting position 612, a second connecting position 614, and an intermediate portion 616. The first connecting position 612 is connected to the second connecting position 614 via the intermediate portion 616. The first connecting position 612 is closer to the center of the elastic element 610 than the second connecting position 614. That is, the distance between the first connecting position 612 and the center of the elastic element 610 is smaller than the distance between the second connecting position 614 and the center of the elastic element 610.

The elastic element 610 is connected to the fixed part 200 at the first connecting position 612 and is connected to the carrier 100 at the second connecting position 614. The connecting position between the elastic element 610 and the fixed part 200 is closer to the center of the elastic element 610 than the connecting position between the elastic element 610 and the carrier 100.

Since the overall center of mass of the carrier 100 is close to the optical element 10, positioning the elastic element 610 and the supporting element 620 closer toward the optical element 10 in the Z direction allows the rotational center (i.e., pivot point, which is the location where the supporting element 620 contacts the fixed part 200) of the rotational movement of the carrier 100 relative to the fixed part 200 to be closer to the overall center of mass of the carrier 100. As a result, when the carrier 100 is not energized, it will not tilt or deflect due to gravity or the restoring force provided by the elastic element 610. Additionally, this configuration reduces the size of the optical module 1 in the Z direction while simultaneously achieving improved mechanical stability and miniaturization. Furthermore, the provision of the recessed portion 151 enables the optical module 1 to be reduced in size in the Z direction.

Next, reference is made to FIGS. 10 and 11 together. FIG. 10 is a perspective view of the optical module 1, according to certain aspects of the present disclosure, wherein the fixed part 200 and the carrier 100 are shown in dashed lines for illustrative purposes. FIG. 11 is a cross-sectional view of the optical module 1 taken along line B-B of FIG. 1 according to certain aspects of the present disclosure.

The overall driving of the optical module 1 is accomplished by actuating the carrier 100, the fixed part 200 serving as a reference, the supporting assembly 600 serving as the rotational pivot, and the damping assembly together with the elastic element 610 as dynamic stabilizers. The driving is achieved through electromagnetic interaction between the first coil 340, second coil 350, third coil 360, and fourth coil 370 disposed on the fixed part 200, and the corresponding first magnetic element 310, second magnetic element 320, and third magnetic element 330 disposed on the carrier 100.

Overall, the optical element 10 is disposed on the carrier 100 and performs two degrees of rotational freedom about two mutually perpendicular rotational axes: one is rotation about a rotational axis parallel to the Z-axis (the first movement and the second movement in this embodiment), and the other is rotation about a rotational axis parallel to the Y-axis (the third movement).

The Z-axis rotation is shared by two sets of mutually parallel movements—the first movement and the second movement. The first movement is generated by the first coil 340 on the second side 220 of the fixed part 200 and the first magnetic element 310 in the side surface 120 of the carrier 100. When the first coil 340 is energized through the second circuit portion 420, a torque is generated and applied to the carrier 100, causing it to rotate around the pivot defined by the supporting element 620. The sensing element 380 coaxially measures magnetic-field signals to output the position of the carrier 100.

The second movement is generated by the second coil 350 in the third side 230 and the second magnetic element 320 in the side surface 140 of the carrier 100. When the second coil 350 is energized through the third circuit portion 470 and the fourth circuit portion 480, respectively connecting its input/output ends, a torque is generated in the same or parallel direction as that of the first movement and applied to the carrier 100, causing it to rotate around the pivot defined by the supporting element 620. The combined first movement and second movement enable higher Z-axis torque and symmetric driving.

The Y-axis rotation, which is orthogonal to the Z-axis rotation, is generated by the third coil 360 and the fourth coil 370 disposed in the groove 213 of the first side 210, together with the third magnetic element 330 disposed on the rear side 130. The lead wires 361, 362, 371, and 372 drawn from the third coil 360 and the fourth coil 370 through the open channels 214-1, 214-2, 214-3, and 214-4 are electrically connected to the first circuit portion 410. When energized, these coils generate torque acting on the carrier 100, thereby realizing angular motion about the Y-axis.

The vector relationship among the three movements is as follows: the directions of the first movement and the second movement are parallel to each other and jointly correspond to rotation about the Z-axis, while the direction of the third movement is perpendicular to them. Together, these movements provide the optical element 10 with dual-axis angular control sufficient to achieve the prism deflection function, enabling the relative angle between the incident surface 11 and the exit surface 12 to be precisely controlled within an extremely compact volume.

The four-sided structure of the fixed part 200 achieves both electrical conduction and mechanical limiting functions. The first side 210 is provided with the supporting portion 211 to support the first circuit portion 410, and with the tab portions 212 to serve as a limiting and anti-collision stop. The groove 213 accommodates the third coil 360 and the fourth coil 370, while the open channels 214-1, 214-2, 214-3, and 214-4 allow the lead wires 361, 362, 371, and 372 of the third and fourth coils to enter and exit along the shortest routing path, reducing bending and wiring stress. The first side 210 does not fully enclose the third coil 360 and the fourth coil 370, providing both securing and thermal-dissipation effects.

The second side 220 and the third side 230 respectively form coil holes for the first coil 340 and the second coil 350. The surroundings of the first coil 340 and the second coil 350 may be filled and sealed with insulating potting material, thereby improving positioning stability and durability under long-term vibration and temperature cycling.

The actuation and sensing signals of the optical module 1 are routed through the circuit assembly 400. The first circuit portion 410 and the second circuit portion 420 respectively handle the Y-axis and Z-axis actuation channels, and are each attached onto the first reinforcing element 440 and the second reinforcing element 450, which are made of metal. These reinforcing elements have dimensions that at least cover the boundaries of their corresponding circuit portions, and their extending directions are arranged to be non-parallel with the extending directions of the substrate 430 and the third reinforcing element 460. Such a configuration prevents stress concentration on a single weak plane when the module experiences external impact, thereby avoiding cracking.

The substrate 430 connects the first circuit portion 410 and the second circuit portion 420 and is affixed to the third reinforcing element 460, which is in turn connected to the fourth side 240. Further, through fastening between the housing 250 and the third reinforcing element 460, a protective space is formed to prevent dust and micro-particle intrusion. External control signals are input through the connecting portion 432 of the substrate 430, which leads to the external control terminal.

To ensure precision and predictability during actuation, the rotational pivot of the module is defined by the supporting assembly 600. The supporting element 620 is spherical and is placed within the recessed hole 245 of the fourth side 240, at a position adjacent to the exit surface 12. By contacting the metallic reinforcing element 630, the local contact stiffness and wear resistance are enhanced, providing a low-friction geometric pivot point for the carrier 100. The recessed portion 151 on the bottom surface 150 of the carrier 100 positions the supporting element 620 such that its location is closer to the overall center of mass of the carrier 100 in the Z direction, thereby positioning the rotational center of the carrier 100 near the center of mass. This significantly reduces the influence of gravity and the restoring force of the elastic element 610 on static offset.

The elastic element 610 is disposed in the recessed portion 151 and is designed as a plate-like or leaf-spring structure arranged parallel to the incident surface 11. It connects to the fixed part 200 at the first connecting position 612 located near the center of the elastic element 610, and connects to the carrier 100 at the second connecting position 614 located farther from the center. This configuration provides an appropriate restoring torque for small-angle displacements.

To suppress external impacts or high-frequency micro-vibrations, the damping assembly uses elastic materials such as gel to form two sets of connections. The first damping elements 510 connect between the carrier 100 and the first circuit portion 410 and are disposed within the channels 214-1, 214-2, 214-3, and 214-4, thereby controlling relative movement near the Y-axis actuation path. The second damping elements 520 connect between the carrier 100 and the fourth side 240, providing additional damping.

Together with the thicknesses of the tab portion 212 and the supporting portion 211 on the fixed part 200 acting as mechanical stoppers during the movement of the carrier 100, and with the geometric clearance configuration between the protruding edge 152 and the recessed corner 242 of the fixed part, hard collision and boundary interference can be avoided during large-range movements, thereby protecting the integrity of the components.

In summary, the present invention provides an optical module including a fixed part, a driving assembly, a movable part that performs rotational movement, connecting elements, and a supporting element serving as the rotational pivot. In the configuration provided in this disclosure, the overall center of mass of the driving assembly and the movable part is positioned close to the supporting element, and by adjusting the arrangement between the connecting elements and the movable part, the movable part is less susceptible to tilting or deflection caused by gravity or external impacts when in a non-energized state.

Through the above integrated design, not only can the precision and stability of optical element adjustment be effectively improved, but the assembly process can also be simplified, structural reliability enhanced, and overall module miniaturization and process integration promoted. As a result, the position of the optical element can be adjusted to provide more stable optical performance. This enables complex optical adjustment operations to be achieved in a confined space with fewer components, making the invention suitable for applications such as camera modules and optical devices.

Although one or more embodiments of the present disclosure have been illustrated and described with respect to certain implementations, those skilled in the art, upon reading and understanding this specification and the accompanying drawings, will envision equivalents and modifications. In addition, although specific features of the invention may have been disclosed with respect to only one embodiment among several possible embodiments, such features may, as needed and advantageous for any given or particular application, be combined with one or more other features of other embodiments.

Although various embodiments of the present invention have been described above, it should be understood that these embodiments are presented merely by way of example and not by way of limitation. Various modifications may be made to the embodiments disclosed herein without departing from the spirit or scope of the present invention. Therefore, the breadth and scope of the present invention should not be limited by any of the above-described embodiments. Instead, the scope of the present invention should be defined in accordance with the following claims and their equivalents.

The terminology used herein is for the purpose of describing particular embodiments only and is not intended to limit the present invention. As used herein, the singular forms “a,” “an,” and “the” are intended to include the plural forms as well, unless the context clearly indicates otherwise. Furthermore, the terms “including,” “includes,” “having,” “has,” “with,” or variations thereof, as used in the embodiments and/or the claims, are intended to be interpreted in a manner similar to the term “comprising.”

What is claimed is:

1. An optical module, comprising:
a carrier, configured to connect to an optical element;
a fixed part, wherein the carrier is movable relative to the fixed part;
a driving assembly, configured to drive the carrier to move relative to the fixed part; and
a circuit assembly, affixed to the fixed part, wherein the circuit assembly is configured to connect to an external circuit.

2. The optical module as claimed in claim 1, wherein the circuit assembly comprises:
a first circuit portion, having a plate-like structure and a first connecting portion; and
a substrate, made of a plastic or resin material, wherein the first connecting portion is connected to the substrate.

3. The optical module as claimed in claim 2, wherein the circuit assembly further comprises a first reinforcing element having a plate-like structure and a metal material, wherein:
the first circuit portion is disposed on the first reinforcing element; and
a thickness of the first reinforcing element is greater than a thickness of the first circuit portion.

4. The optical module as claimed in claim 3, wherein when viewed along a direction of the thickness of the first reinforcing element, a boundary of the first circuit portion at least partially overlaps the first reinforcing element.

5. The optical module as claimed in claim 3, wherein the circuit assembly further comprises:
a second circuit portion, having a plate-like structure and a second connecting portion, wherein the second connecting portion is connected to the substrate; and
a second reinforcing element, wherein the second circuit portion is disposed on the second reinforcing element; wherein
the second reinforcing element has a metal material.

6. The optical module as claimed in claim 5, wherein the circuit assembly further comprises a third reinforcing element, wherein:
the substrate is disposed on the third reinforcing element;
the first reinforcing element, the third reinforcing element, and the second reinforcing element have an integrally formed structure; and
the first circuit portion, the substrate, and the second circuit portion have an integrally formed structure.

7. The optical module as claimed in claim 6, wherein:
the extending direction of the first reinforcing element and the extending direction of the third reinforcing element are not parallel to each other;
the extending direction of the second reinforcing element and the extending direction of the third reinforcing element are not parallel to each other;
the extending direction of the first circuit portion and the extending direction of the substrate are not parallel to each other; and
the extending direction of the second circuit portion and the extending direction of the substrate are not parallel to each other.

8. The optical module as claimed in claim 5, wherein the fixed part comprises:
a supporting portion, having a plate-like structure; and
a tab portion, wherein the first circuit portion is at least partially located between the supporting portion and the tab portion, wherein
the tab portion is configured to limit movement of the carrier within an extreme range; and
a maximum thickness of the tab portion is greater than a maximum thickness of the supporting portion.

9. The optical module as claimed in claim 8, wherein:
a maximum thickness of the supporting portion is greater than a maximum thickness of the first circuit portion; and
the maximum thickness of the supporting portion is less than a maximum thickness of the first reinforcing element.

10. The optical module as claimed in claim 8, wherein the fixed part further comprises:
a groove, configured to accommodate a portion of the driving assembly; and
a plurality of channels, extending from the groove to an edge of the fixed part to form open channels, wherein
the extending directions of the channels are parallel to each other; and
the tab portion is located between the channels.

11. The optical module as claimed in claim 10, wherein the driving assembly comprises:
a plurality of magnetic elements, disposed on the carrier; and
a plurality of coils, wherein lead wires of the coils are disposed in the channels.

12. The optical module as claimed in claim 10, wherein the circuit assembly further comprises:
a third circuit portion, extending from the substrate, parallel to the second circuit portion, and connected to one end of one of the coils; and
a fourth circuit portion, extending from the substrate, parallel to the second circuit portion, and connected to another end of the coil.

13. The optical module as claimed in claim 2, further comprising a damping assembly, configured to suppress abnormal vibration of the carrier, wherein a first damping element of the damping assembly is in direct contact with the circuit assembly.

14. The optical module as claimed in claim 13, wherein the first damping element is in direct contact with the first circuit portion.

15. The optical module as claimed in claim 13, wherein the first damping element is located in channels of the fixed part, and the first circuit portion and the carrier are movably connected by the first damping elements.

16. The optical module as claimed in claim 13, wherein the damping assembly further comprises a second damping element that is in direct contact with the fixed part.

17. The optical module as claimed in claim 1, wherein:
the carrier includes a protruding edge, extending along the optical element;
the fixed part includes a recessed corner, adjacent to the protruding edge, wherein
the recessed corner is configured to be recessed on the side facing the protruding edge, and
the recessed corner is configured to protrude toward the circuit assembly.

18. The optical module as claimed in claim 1, further comprising a supporting assembly, wherein the carrier is movable relative to the fixed part through the supporting assembly, the supporting assembly comprising:
a supporting element, movable relative to both the carrier and the fixed part;
a reinforcing element, disposed on the fixed part, having a metal material, and in direct contact with the supporting element; and
an elastic element, disposed between the carrier and the fixed part.

19. The optical module as claimed in claim 18, wherein:
the supporting element is spherical and is disposed in a recessed hole of the fixed part; and
the recessed hole is located closer to the center of mass of the carrier.

20. The optical module as claimed in claim 18, wherein the elastic element comprises:
a first connecting position, connected to the fixed part; and
a second connecting position, connected to the carrier, wherein:
the first connecting position is closer to a center of the elastic element than the second connecting position.
